(19) United States
(12) Patent Application Publication
(10) Pub. No.: US 2007/0259238 A1
(43) Pub. Date: Nov. 8, 2007

(54) Novel fabrication method for fuel cell membranes with high performance and long lifetime

(76) Inventor: Jun Guo, Richmond, KY (US)

Correspondence Address: JUN GUO;PROMISSING ENERGY, LLC., 103 DOGWOOD CIRCLE, RICHMOND, KY, 40475, US

(21) Appl. No.: 11/397,840

(22) Filed: Apr. 3, 2006

Related U.S. Application Data
(60) Provisional application No. 60/668,568, filed on Apr. 4, 2005.

(51) Int. Cl. H01M 2/16

(52) U.S. Cl. 429/33; 521/25

(57) ABSTRACT

This invention relates to the use of a blend of polymers for the preparation of membranes to perform as the solid electrolyte for hydrogen and methanol fuel cells (FC), which operate at temperatures above 100° C. Said membranes should have as little permeability to the fuel and oxidant as possible and allow facile transport of protons; which results in more efficient electrochemical reactions and improved FC performance. During device operation, the membrane is exposed to aggressive chemical environments occurring at the electrodes, particularly at the cathode, where a highly oxidative environment is known to exist. Therefore, this invention claims hydrocarbon-based polymer blends that have improved resistance to said environments.

### FIELD OF THE INVENTION

This invention relates to the use of a blend of polymers for the preparation of membranes to perform as the solid electrolyte for hydrogen and methanol fuel cells.

### BACKGROUND OF THE INVENTION

A fuel cell is an electrochemical device in which the chemical energy of a reaction between a fuel and an oxidant is converted into electricity. The basic fuel cell unit comprises an electrolyte layer, also called a membrane, in contact with a porous anode and cathode, which themselves are located on either side of the membrane. In a typical fuel cell, a gaseous or liquid fuel is continuously fed to the anode electrode, sometimes referred to as the fuel electrode, while simultaneously an oxidant, such as air or pure oxygen, is continuously fed to the cathode electrode, sometimes referred to as the air electrode. The fuel is oxidized at the anode side to protons, which migrate through the membrane to the cathode, which then participate in the reduction of the oxidant. Due to the limited electricity generating capacity of an individual fuel cell, a plurality of fuel cell units are typically stacked one on top of another with a bipolar separator plate separating the fuel cell units between the anode electrode of one fuel cell unit and the cathode electrode of an adjacent fuel cell unit.

There are a number of different fuel cell types other than the one describe above that are classified using a variety of categories, such as: the type of fuel and oxidant, whether the fuel is processed external to or inside the fuel cell, and the type of electrolyte. Solid oxides, phosphoric acid, molten carbonate, and proton exchange membranes, are all examples of materials that have been used as electrolytes in the construction of fuel cells.

In a proton exchange membrane fuel cell, also sometimes referred to as a polymer electrolyte membrane fuel cell, the electrolyte is the proton conducting membrane, which is sandwiched between two porous electrodes. The polymers most commonly used in the construction of the proton exchange membrane for fuel cells consists of a perfluorinated sulfonic acid polymer, an example of which is duPont's Nafion®. Polymers of this type consist of a fluoropolymer backbone upon which sulfonic acid groups are chemically bonded. They have exceptionally high chemical and thermal stability, and are stable against chemical attack in strong bases, strong oxidizing and reducing agents, which include: H₂O₂, Cl₂, H₂, and O₂. However, Nafion does have several limitations:
(1) The membranes are permeable to methanol, a problem for DMFCs
(2) Due to the high amount of fluorine, cost of the polymer is an issue

The challenge therefore, to those working in the field is to find lower cost alternatives, while maintaining the desired properties mentioned above.

### PRIOR ART

Dias-Analytical's patents U.S. Pat. No. 5,468,574, and U.S. Pat. No. 5,679,482 claim highly conductive membranes, its process, and its use in fuel cell applications. The composition of the membrane comprises at least one vinyl aromatic compound bonded to a least one flexible connecting polymer segment. The degree of sulfonation is claimed to be at least 25%, wherein the sulfonating agent is chosen from the group consisting of acetyl sulfate, SO₃ acetic acid, SO₃ lauric acid, chlorosulfonic acid, lauric acid, chlorosulfonic acid, and trimentylsilyl sulfonyl chloride, respectively.

Kaneka Corporation's patent application JP2001210336A claims polymer membranes for fuel cells that consist of sulfonated copolymers, where said copolymers are comprised of isobutylene and aromatic vinyl monomers. The aromatic vinyl monomers include styrene, α-methyl styrene, p-methyl styrene, vinyl naphthalene derivatives, and indene derivatives. The ion exchange capacity of the sulfonated product is claimed to be 0.50 meq/g or more.

### SUMMARY OF THE INVENTION

The present invention provides a fluorine-free low cost proton conducting membrane suitable for use in proton exchange membrane fuel cells. More particularly, the present invention provides a formulation that contains a blend of polymers and a small molecular plasticizer. The composition exhibits improved physical properties as compared to prior art compositions, including high stability and high proton conductivity.

### DESCRIPTION OF THE INVENTION

The proton exchange membrane is comprised of a combination of polymeric and small molecular materials as listed bellow

Polymer(s) I: Poly(styrene-co-(ethylene-ran-butylene)-co-styrene) (SEBS), with the phenyl moiety either partially or fully sulfonated with —SO₃H group 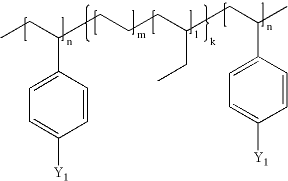
where
n, m, l and k are either zero or integers from 1 to 10⁶;
Y₁ is SO₃H;
   in the case where the phenyl moiety is partially sulfonated Y₁ will also include H, such that Y₁ is further defined as H, SO₃H and mixtures thereof. Polymer(s) I serves as an elastomer to improve the tensile strength of the membrane.

Polymer(s) II: Poly(□-methylstyrene) (□-MeSt), with the phenyl moiety either partially or fully sulfonated with —SO₃H group 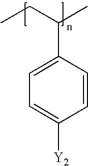
where
n is either zero or integers from 1 to 10⁶;
Y₂ is SO₃H;
   in the case where the phenyl moiety is partially sulfonated Y₂ will also include H, such that Y₂ is further defined as H, SO₃H and mixtures thereof. Polymer(s) II add chemical stability to the membrane and further improve the proton conductivity.

Small molecule I: Tetraphenylmethane (TPM), with the phenyl moiety either partially or fully sulfonated with —SO₃H group 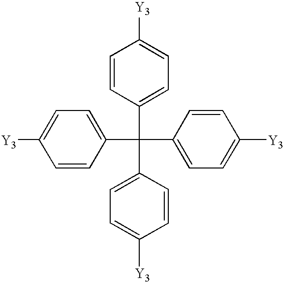
where
Y₃ is SO₃H;
   in the case where the phenyl moiety is partially sulfonated Y₃ will also include H, such that Y₃ is further defined as H, SO₃H and mixtures thereof; This sulfonated Small Molecule I material serves as plasticizer to improver the film quality and further increase the membrane conductivity.
   wherein each material contributes to the overall properties of the membrane.

### EXAMPLES

The following examples describe the procedures by which the membranes of this invention maybe synthesized. These descriptions are exemplary in nature and should not in any way be deemed as limiting the scope of this invention.

For examples, the ion-conducting polymers are prepared from the following polymeric and small molecular materials, by sulfonating the phenyl moiety. The phenyl moiety is either partially or fully sulfonated by using the suitable amount of sulfonating agents, such as oleum, acetyl sulfate, etc.

### Example 1

### Sulfonation of Blends of SEBS, □-MeSt and TPM with Oleum

A mixture of 10 grams of SEBS (with a Mw of 80,000 and 30% (w/w) styrene content), 3 grams of □-MeSt (with a Mw of 9000), and 0.13 grams of TPM, is dissolved for two hours in 80 grams of oleum (H₂SO₄+30% SO₃). The temperature of the reaction is maintained below 40° C. After 10 minutes, the reaction is poured into 500 grams of ice-water so that the temperature does not exceed 40° C. The sulfonated product is precipitated with methanol and collected as a brown solid.

### Example 2

### Sulfonation of Blends of SEBS, □-MeSt and TPM with Acetyl Sulfate

The sulfonating agent, acetyl sulfate, is freshly prepared by adding a measured amount of acetic anhydride (5.63 grams) in 1,2-dichloroethane (20 mL) under a nitrogen atmosphere. The solution is cooled to about 5° C., after which 5.61 grams of concentrated sulfuric acid (96.5%) is added while the nitrogen is flowing. The mixture is stirred at 5° C. for 10 minutes.

A mixture of 10 grams of SEBS (with a Mw of 80,000 and 30% (w/w) styrene content), 3 grams of □-MeSt (with a Mw of 9000), and 0.13 grams of TPE is dissolved in 180 mL of 1,2-dichloroethane and 75 mL of cyclohexane in a 500 mL 3-neck round bottom flask fitted with a mechanical stirrer, condenser and an additional funnel with a nitrogen inlet.

What is claimed is:

1. An ion conducting polymer composition comprising
Poly(styrene-co-(ethylene-ran-butylene)-co-styrene) (SEBS), with the phenyl moiety either partially or fully sulfonated with —SO₃H group 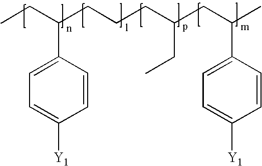
where
n, m, l and p are either zero or integers from 1 to 10⁶;
Y₁ is SO₃H;
in the case where the phenyl moiety is partially sulfonated Y₁ will also include H, such that Y₁ is further defined as H, SO₃H and mixtures thereof.

2. An ion conducting polymer composition comprising
Poly(α-methylstyrene) (α-MeSt), with the phenyl moiety either partially or fully sulfonated with —SO₃H group 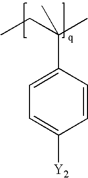
where
q is either zero or integers from 1 to 10⁶;
Y₂ is SO₃H;
in the case where the phenyl moiety is partially sulfonated Y₂ will also include H, such that Y₂ is further defined as H, SO₃H and mixtures thereof.

3. An ion conducting polymer composition comprising
Tetraphenylmethane (TPM), with the phenyl moiety either partially or fully sulfonated with —SO₃H group 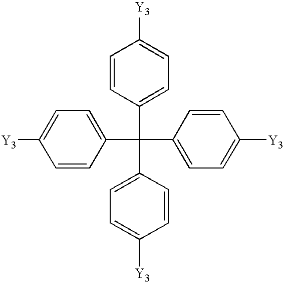
where
Y₃ is SO₃H;
in the case where the phenyl moiety is partially sulfonated Y₃ will also include H, such that Y₃ is further defined as H, SO₃H and mixtures thereof.

4. An ion conducting polymer composition comprised of polymers of claim 1 that is used in combination with polymers of claim 2.

5. An ion conducting polymer composition comprised of polymers of claim 1 that is used in combination with polymers of claim 3.

6. An ion conducting polymer composition comprised of polymers of claim 2 that is used in combination with polymers of claim 3.

7. An ion conducting polymer composition comprised of polymers of claim 3 that is used in combination with polymers of claim 4.

8. An ion exchange membrane comprised of proton conducting polymers and compositions according to claims 1-7.

9. A fuel cell comprising an ion exchange membrane according to claim 8.
